(19) United States
(12) Patent Application Publication
(10) Pub. No.: US 2025/0112731 A1
(43) Pub. Date: Apr. 3, 2025

(54) UPLINK REPETITION FREQUENCY HOPPING IN MIXED SUB-BAND FULL DUPLEX AND NON-SUB-BAND FULL DUPLEX SLOTS

(71) Applicant: QUALCOMM Incorporated, San Diego, CA (US)

(72) Inventors: Muhammad Sayed Khairy ABDELGHAFFAR, San Jose, CA (US); Abdelrahman Mohamed Ahmed Mohamed IBRAHIM, San Diego, CA (US); Gokul SRIDHARAN, Sunnyvale, CA (US); Yi HUANG, San Diego, CA (US); Peter GAAL, San Diego, CA (US)

(21) Appl. No.: 18/830,371

(22) Filed: Sep. 10, 2024

Related U.S. Application Data
(60) Provisional application No. 63/586,095, filed on Sep. 28, 2023.

(51) Int. Cl. H04L 1/08; H04L 5/00

(52) U.S. Cl. CPC H04L 1/08; H04L 5/001

(57) ABSTRACT

Methods, systems, and devices for wireless communications are described. The described technique provide for a user equipment (UE) to selectively transmit an uplink repetition configured with intra-slot frequency hopping during a slot including both sub-band full duplex (SBFD) and non-SBFD symbols. For example, the UE may receive a control message scheduling repetitions of an uplink message and indicating a configuration for intra-slot frequency hopping for the repetitions. In some cases, the UE may selectively transmit a repetition during a mixed symbol slot according to whether the slot is considered available, an alignment of a boundary between the SBFD symbols and non-SBFD symbols of the mixed symbol slot with time resources for portions of the repetition, transmission parameters associated with SBFD symbols and non-SBFD symbols, or any combination thereof.

### CROSS REFERENCE

The present Application for Patent claims the benefit of U.S. Provisional Patent Application No. 63/586,095 by ABDELGHAFFAR et al., entitled “UPLINK REPETITION FREQUENCY HOPPING IN MIXED SUB-BAND FULL DUPLEX AND NON-SUB-BAND FULL DUPLEX SLOTS,” filed Sep. 28, 2023, assigned to the assignee hereof, and expressly incorporated by reference herein.

### FIELD OF TECHNOLOGY

The following relates to wireless communications, including uplink repetition frequency hopping in mixed sub-band full duplex (SBFD) and non-SBFD slots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink repetition frequency hopping in mixed sub-band full duplex and non-sub-band full duplex slots. For example, the described techniques provide for a user equipment (UE) to selectively transmit an uplink repetition configured with intra-slot frequency hopping during a mixed symbol slot (e.g., a slot including both sub-band full duplex (SBFD) and non-SBFD symbols). Such slots may include a first set of symbols associated with SBFD communications (e.g., associated with one or more downlink sub-bands as well as one or more uplink sub-bands) and a second set of symbols associated with unidirectional communications (e.g., a bandwidth or bandwidth part dedicated to uplink communications or downlink communications). In some cases, the UE may transmit an uplink message (e.g., to a network device) and one or more repetitions of the uplink message. Additionally, the UE may receive a configuration for intra-slot frequency hopping for each transmission of the uplink message. For example, each repetition of the uplink message may include one or more frequency hops within a slot (e.g., a separation in frequency between portions of a repetition). In some cases, the UE may selectively transmit such a repetition during a mixed symbol slot according to whether the slot is considered available (e.g., based on a counting perspective of the UE), an alignment of a boundary between the SBFD symbols and non-SBFD symbols of the mixed symbol slot with a time domain location of a frequency hop of the repetition, transmission parameters associated with SBFD symbols and non-SBFD symbols, or any combination thereof.

A method for wireless communications by a UE is described. The method may include receiving a control message including scheduling information for a set of multiple repetitions of an uplink message for transmission by the UE, the scheduling information indicating an intra-slot frequency hopping configuration for each repetition of the set of multiple repetitions and selectively transmitting, during a slot including a first set of symbols associated with SBFD communications and a second set of symbols associated with uplink communications, one or more portions of a repetition of the set of multiple repetitions based on one or both of an availability of the slot and a boundary between the first set of symbols and the second set of symbols relative to time resources associated with the one or more portions of the repetition, where the time resources are based on one or more frequency hops indicated by the intra-slot frequency hopping configuration.

A UE for wireless communications is described. The UE may include one or more memories storing processor executable code, and one or more processors coupled with the one or more memories. The one or more processors may individually or collectively operable to execute the code to cause the UE to receive a control message including scheduling information for a set of multiple repetitions of an uplink message for transmission by the UE, the scheduling information indicating an intra-slot frequency hopping configuration for each repetition of the set of multiple repetitions and selectively transmit, during a slot including a first set of symbols associated with SBFD communications and a second set of symbols associated with uplink communications, one or more portions of a repetition of the set of multiple repetitions based on one or both of an availability of the slot and a boundary between the first set of symbols and the second set of symbols relative to time resources associated with the one or more portions of the repetition, where the time resources are based on one or more frequency hops indicated by the intra-slot frequency hopping configuration.

Another UE for wireless communications is described. The UE may include means for receiving a control message including scheduling information for a set of multiple repetitions of an uplink message for transmission by the UE, the scheduling information indicating an intra-slot frequency hopping configuration for each repetition of the set of multiple repetitions and means for selectively transmitting, during a slot including a first set of symbols associated with SBFD communications and a second set of symbols associated with uplink communications, one or more portions of a repetition of the set of multiple repetitions based on one or both of an availability of the slot and a boundary between the first set of symbols and the second set of symbols relative to time resources associated with the one or more portions of the repetition, where the time resources are based on one or more frequency hops indicated by the intra-slot frequency hopping configuration.

A non-transitory computer-readable medium storing code for wireless communications is described. The code may include instructions executable by a processor to receive a control message including scheduling information for a set of multiple repetitions of an uplink message for transmission by the UE, the scheduling information indicating an intra-slot frequency hopping configuration for each repetition of the set of multiple repetitions and selectively transmit, during a slot including a first set of symbols associated with SBFD communications and a second set of symbols associated with uplink communications, one or more portions of a repetition of the set of multiple repetitions based on one or both of an availability of the slot and a boundary between the first set of symbols and the second set of symbols relative to time resources associated with the one or more portions of the repetition, where the time resources are based on one or more frequency hops indicated by the intra-slot frequency hopping configuration.

In some examples of the method, UEs, and non-transitory computer-readable medium described herein, selectively transmitting the one or more portions of the repetition may include operations, features, means, or instructions for refraining from transmitting the one or more portions of the repetition during the slot based on a determination that the slot may be unavailable, where the slot may be determined to be unavailable based on the slot being associated with both the SBFD communications and the uplink communications.

In some examples of the method, UEs, and non-transitory computer-readable medium described herein, refraining from transmitting the one or more portions of the repetition may include operations, features, means, or instructions for postponing transmission of the one or more portions of the repetition until a second slot subsequent to the slot, where the second slot may be available based on each symbol of the second slot being associated with the uplink communications.

In some examples of the method, UEs, and non-transitory computer-readable medium described herein, refraining from transmitting the one or more portions of the repetition may include operations, features, means, or instructions for dropping the one or more portions of the repetition during the slot and incrementing a counter associated with the set of multiple repetitions based on dropping the one or more portions of the repetition, where incrementing the counter indicates a completion of the repetition.

In some examples of the method, UEs, and non-transitory computer-readable medium described herein, the one or more portions of the repetition include at least a first portion and a second portion that may be separated, in a frequency domain, by a first frequency hop of the one or more frequency hops and first time resources associated with the first portion may be within the first set of symbols and second time resources associated with the second portion may be within the second set of symbols based on a time domain location of the first frequency hop aligning with the boundary between the first set of symbols and the second set of symbols.

In some examples of the method, UEs, and non-transitory computer-readable medium described herein, selectively transmitting the one or more portions of the repetition may include operations, features, means, or instructions for transmitting the first portion and the second portion during the slot based on the first time resources being within the first set of symbols and the second portion being within the second set of symbols and incrementing a counter associated with the set of multiple repetitions based on transmitting the first portion and the second portion, where incrementing the counter indicates a completion of the repetition.

In some examples of the method, UEs, and non-transitory computer-readable medium described herein, transmitting the one or more portions of the repetition may include operations, features, means, or instructions for transmitting, during the first time resources, the first portion in accordance with a first set of transmission parameters associated with the SBFD communications and transmitting, during the second time resources, the second portion in accordance with a second set of transmission parameters associated with the uplink communications.

In some examples of the method, UEs, and non-transitory computer-readable medium described herein, selectively transmitting the one or more portions of the repetition may include operations, features, means, or instructions for refraining from transmitting the first portion and the second portion during the slot based on the SBFD communications being associated with a first set of transmission parameters that may be different from a second set of transmission parameters associated with the uplink communications.

In some examples of the method, UEs, and non-transitory computer-readable medium described herein, the one or more portions of the repetition include at least a first portion and a second portion that may be separated, in a frequency domain, by a first frequency hop of the one or more frequency hops and first time resources associated with the first portion may be within the first set of symbols and second time resources associated with the second portion may be at least partially within both the first set of symbols and the second set of symbols.

In some examples of the method, UEs, and non-transitory computer-readable medium described herein, selectively transmitting the one or more portions of the repetition may include operations, features, means, or instructions for refraining from transmitting the first portion and the second portion during the slot based on the second time resources being at least partially within both the first set of symbols and the second set of symbols.

In some examples of the method, UEs, and non-transitory computer-readable medium described herein, selectively transmitting the one or more portions of the repetition may include operations, features, means, or instructions for transmitting the first portion during the first time resources and dropping the second portion based on the second time resources being at least partially within both the first set of symbols and the second set of symbols.

In some examples of the method, UEs, and non-transitory computer-readable medium described herein, selectively transmitting the one or more portions of the repetition may include operations, features, means, or instructions for transmitting the one or more portions of the repetition during the slot based on a determination that the slot may be available, where the slot may be determined to be available based on both a first set of transmission parameters associated with the SBFD communications and a second set of transmission parameters associated with the uplink communications including a same set of transmission parameters.

In some examples of the method, UEs, and non-transitory computer-readable medium described herein, the same set of transmission parameters includes a transmission power, a phase, a transmission timing parameter, a quasi-co-location (QCL) relationship, a guard period, or any combination thereof.

### BRIEF DESCRIPTION OF THE DRAWINGS

FIG. 1 shows an example of a wireless communications system that supports uplink repetition frequency hopping in mixed sub-band full duplex (SBFD) and non-SBFD slots in accordance with one or more aspects of the present disclosure.

FIG. 2 shows an example of a wireless communications system that supports uplink repetition frequency hopping in mixed SBFD and non-SBFD slots in accordance with one or more aspects of the present disclosure.

FIGS. 3A and 3B show examples of mixed symbol slots that support uplink repetition frequency hopping in mixed SBFD and non-SBFD slots in accordance with one or more aspects of the present disclosure.

FIG. 4 shows an example of a process flow that supports uplink repetition frequency hopping in mixed SBFD and non-SBFD slots in accordance with one or more aspects of the present disclosure.

FIGS. 5 and 6 show block diagrams of devices that support uplink repetition frequency hopping in mixed SBFD and non-SBFD slots in accordance with one or more aspects of the present disclosure.

FIG. 7 shows a block diagram of a communications manager that supports uplink repetition frequency hopping in mixed SBFD and non-SBFD slots in accordance with one or more aspects of the present disclosure.

FIG. 8 shows a diagram of a system including a device that supports uplink repetition frequency hopping in mixed SBFD and non-SBFD slots in accordance with one or more aspects of the present disclosure.

FIG. 9 shows a flowchart illustrating methods that support uplink repetition frequency hopping in mixed SBFD and non-SBFD slots in accordance with one or more aspects of the present disclosure.

### DETAILED DESCRIPTION

In some wireless communications systems, wireless devices may transmit one or more repetitions of a message to support successful reception of the message. For example, a user equipment (UE) may transmit an uplink message and may transmit one or more repetitions of the uplink message. In some cases, the UE may receive scheduling information that indicates an intra-slot frequency hopping configuration for each repetition of the uplink message. For example, the UE may transmit a repetition in one or more portions during a slot, which may be transmitted at respective frequencies in accordance with the intra-slot frequency hopping configuration. The UE may determine which slots to use for transmission of the repetitions according to a counting perspective of the UE, such as available slot counting or consecutive physical slot counting. In some cases, such slots may include one or more mixed symbol slots, which may include both sub-band full duplex (SBFD) and non-SBFD symbols. If the UE is an SBFD-aware UE (e.g., a UE capable of identifying an SBFD configuration of a slot), the UE may consider such a slot for transmission of a repetition of the uplink message. However, the UE may be unable to determine whether a mixed symbol slot is suitable or available for transmitting a repetition, which may interfere with the UE communicating the repetition to a network device. In some cases, the UE may determine the availability for transmission of the repetition in the slot based on configuration of the same transmission parameters for both SBFD and non-SBFD symbols and the lack of the guard period between the two symbol types.

To support communicating repetitions of an uplink message during slots that include one or more mixed symbol slots, a UE may selectively transmit a repetition during a mixed symbol slot according to one or more conditions. The one or more conditions may be associated with an availability of the slot, a time domain location of a frequency hop of the repetition relative to a boundary between SBFD symbols and non-SBFD symbols of the slot, or both. For example, the UE may consider the slot unavailable due to the slot including both SBFD and non-SBFD symbols, and may refrain from transmitting a repetition during the slot (e.g., postponing or dropping the repetition) due to the slot being unavailable.

As an alternative, the UE may determine whether to transmit the repetition during the slot based on whether time domain resources for portions of the repetition are within a same symbol type. For example, if time resources for a first portion of the repetition are within the SBFD symbols and time resources for a second portion of the repetition are within the non-SBFD symbols (e.g., a time domain location of the frequency hop aligns with a boundary between the SBFD symbols and non-SBFD symbols), the UE may determine to transmit the repetition during the slot. As another example, if the time resources for the second portion of the repetition extend into both the SBFD symbols and the non-SBFD symbols, the UE may determine to drop the repetition (e.g., both portions are dropped) or may determine to drop the second portion (e.g., while transmitting the first portion). Such techniques may improve communication of uplink repetitions during mixed symbol slots.

Aspects of the disclosure are initially described in the context of wireless communications systems. Aspects of the disclosure are further illustrated by and described with reference to mixed symbol slots and a process flow. Aspects of the disclosure are further illustrated by and described with reference to apparatus diagrams, system diagrams, and flowcharts that relate to uplink repetition frequency hopping in mixed SBFD and non-SBFD slots.

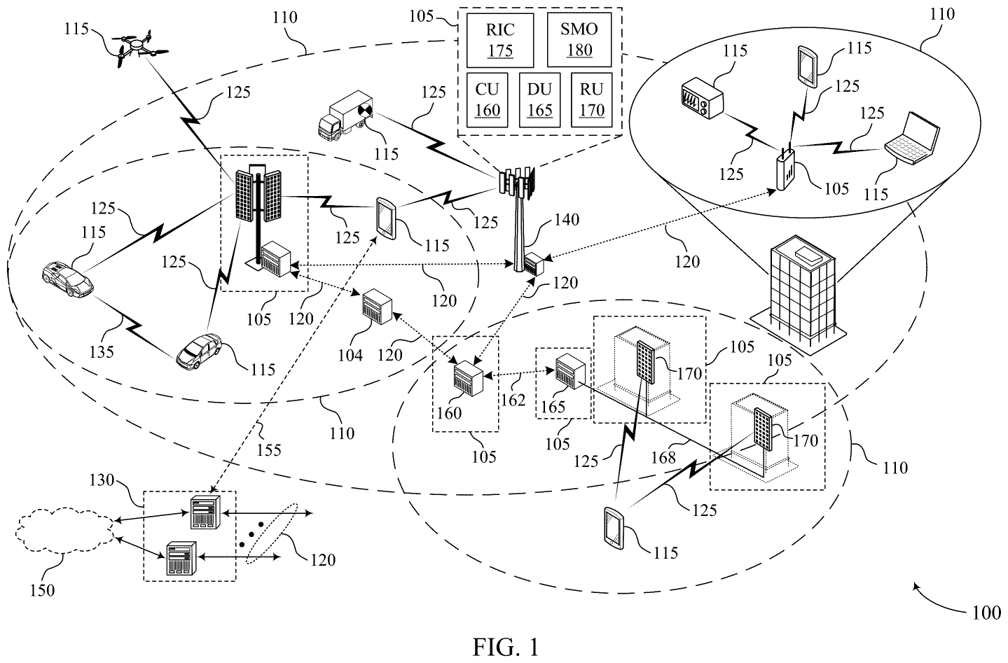

FIG. 1 shows an example of a wireless communications system 100 that supports uplink repetition frequency hopping in mixed SBFD and non-SBFD slots in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink repetition frequency hopping in mixed SBFD and non-SBFD slots as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may support a UE 115 selectively transmitting an uplink repetition configured with intra-slot frequency hopping during a mixed symbol slot. Such slots may include a first set of symbols associated with SBFD communications (e.g., including one or more downlink sub-bands and one or more uplink sub-bands) and a second set of symbols associated with unidirectional communications (e.g., a bandwidth or bandwidth part dedicated to uplink communications or downlink communications). In some cases, the UE 115 may transmit an uplink message (e.g., to a network entity 105) and one or more repetitions of the uplink message. Further, the UE 115 may receive a configuration for intra-slot frequency hopping for each transmission of the uplink message. For example, each repetition of the one or more repetitions may include one or more frequency hops within a slot. In some cases, the UE 115 may selectively transmit such a repetition during a mixed symbol slot according to whether the slot is considered available, a boundary between the SBFD symbols and non-SBFD symbols of the mixed symbol slot relative to a time domain location of a frequency hop of the repetition, transmission parameters associated with SBFD symbols and non-SBFD symbols, or any combination thereof.

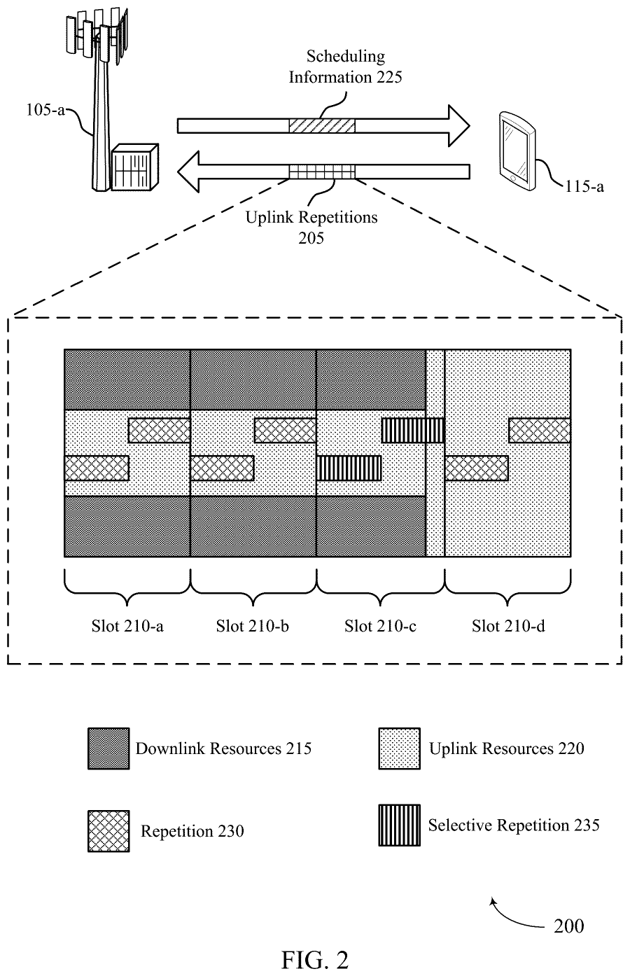

FIG. 2 shows an example of a wireless communications system 200 that supports uplink repetition frequency hopping in mixed SBFD and non-SBFD slots in accordance with one or more aspects of the present disclosure. The wireless communications system 200 may implement, or be implemented by, one or more aspects of the wireless communications system 100. For example, the wireless communications system 200 may include a UE 115-a and a network entity 105-a, which may be examples of corresponding devices described with reference to FIG. 1. In some cases, the wireless communications system 200 may support the UE 115-a (e.g., an SBFD-aware UE) selectively transmitting a repetition of an uplink message during a mixed symbol slot according to one or more conditions. It should be noted that the techniques described herein may be applied to mixed symbol slots that transition from non-SBFD symbols to SBFD symbols, and are not limited to the example illustrated by FIG. 2.

In some examples, the UE 115-a may transmit one or more uplink repetitions 205 (e.g., repetitions of an uplink message, such as a physical uplink control channel (PUCCH) message or a physical uplink shared channel (PUSCH) message) during a set of slots 210, which may include a slot 210-a, a slot 210-b, a slot 210-c, and a slot 210-d. In some cases, the set of slots 210 may include one or more SBFD slots (e.g., the slot 210-a and the slot 210-b), one or more mixed symbol slots (e.g., the slot 210-c), and one or more uplink slots (e.g., the slot 210-d). For example, the slot 210-a and the slot 210-b may include one or more downlink sub-bands (e.g., portions of the bandwidth allocated to downlink resources 215) and one or more uplink sub-bands (e.g., portions of the bandwidth allocated to uplink resources 220) and the slot 210-d may include a bandwidth allocated with uplink resources 220 (e.g., an uplink slot). Additionally, the slot 210-c may include both SBFD symbols and non-SBFD symbols (e.g., a mixed symbol slot). For example, the slot 210-c may include a first set of symbols associated with both downlink resources 215 and uplink resources 220 (e.g., SBFD symbols) and a second set of symbols associated with uplink resources 220 (e.g., non-SBFD symbols).

In some cases, the network entity 105-a may transmit scheduling information 225 to the UE 115-a, which may indicate an intra-slot frequency hopping configuration for the UE 115-a to use for transmitting the uplink repetitions 205. The intra-slot frequency hopping configuration may indicate one or more frequency hops within a slot 210 for each repetition of the uplink message. As an example, the intra-slot frequency hopping configuration may indicate hop (e.g., a separation in frequency) between a first portion of a repetition and a second portion of the repetition and a time domain location where the UE 115-a is to perform the hop. In some cases, the UE 115-a may apply the intra-slot frequency hopping configuration for each repetition of the uplink message (e.g., each repetition may be partitioned within a slot according to the same frequency hopping configuration). It should be noted that the intra-slot frequency hopping configuration may indicate any quantity of frequency hops within a slot.

The UE 115-a may transmit the uplink repetitions 205 during the set of slots 210 according to the intra-slot frequency hopping configuration. As an illustrative example, the UE 115-a may transmit a first repetition 230 during the slot 210-a in a first portion and a second portion that are based on a frequency hop indicated by the intra-slot frequency hopping configuration (e.g., indicating a time domain location of the frequency hop and a frequency separation for the frequency hop). For example, the first portion of the first repetition 230 may span a first set of symbols in the slot 210-a at a first frequency location (e.g., within an uplink sub-band of the slot 210-a) and the second portion of the first repetition 230 may span a second set of symbols in the slot 210-a at a second frequency location different from the first frequency location (e.g., within the uplink sub-band). Similarly, the UE 115-a may transmit a second repetition 230 during the slot 210-b according to the intra-slot frequency hopping configuration (e.g., transmitting the second repetition 230 in a first portion and a second portion).

In some examples, the UE 115-a may determine whether to transmit a selective repetition 235 during the slot 210-c based on the slot 210-c being a mixed symbol slot. For example, the UE 115-a may refrain from transmitting the selective repetition 235 during the slot 210-c based on the slot 210-c including both SBFD symbols and non-SBFD symbols and the time resources for the selective repetition 235 spanning both the SBFD symbols and the non-SBFD symbols (e.g., mixed symbol slots are considered unsuitable for repetitions configured with frequency hopping).

Further, a counting perspective of the UE 115-a may indicate how the UE 115-a handles such refraining. In one example, if the UE 115-a counts slots according to available slot counting (e.g., available slot counting is enabled), the UE 115-a may consider the slot 210-c as unavailable and may postpone the selective repetition 235 until a subsequent available slot (e.g., a next available slot, such as the slot 210-d). In such examples, the UE 115-a may refrain from incrementing a counter associated with the uplink repetitions 205 (e.g., a counter indicating how many of the uplink repetitions 205 have been completed). For example, the repetition 230 during the slot 210-a may be counted as a first repetition, the repetition 230 during the slot 210-b may be counted as a second repetition, and a repetition 230 during the slot 210-d may be counted as a third repetition. In another example, if the UE 115-a counts slots according to consecutive physical slot counting, the UE 115-a may drop the selective repetition 235 and may increment the counter associated with the uplink repetitions 205 (e.g., indicating the selective repetition 235 has been completed despite not transmitting the selective repetition 235). For example, the repetition 230 during the slot 210-a may be counted as a first repetition, the repetition 230 during the slot 210-b may be counted as a second repetition, the dropped selective repetition 235 may be counted as a third repetition, and the repetition 230 during the slot 210-d may be counted as a fourth repetition.

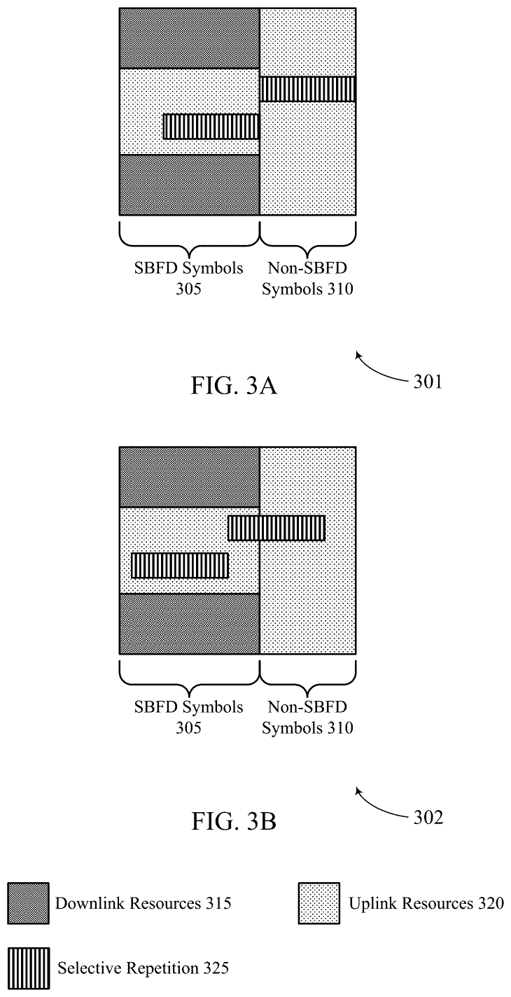

In some other examples, the UE 115-a may determine whether to transmit the selective repetition 235 during the slot 210-c based on an alignment of a boundary between the SBFD symbols and non-SBFD symbols (e.g., a point in time where the type of symbol changes) and time resources associated with the portions of the selective repetition 235. For example, the UE 115-a may selectively transmit the selective repetition 235 based on whether each portion of the selective repetition 235 is contained within a same type of symbol or based on whether at least one portion of the selective repetition 235 extends into both the SBFD symbols and non-SBFD symbols, as described further below with reference to FIGS. 3A and 3B, respectively. In such examples, the UE 115-a may further determine whether to transmit the selective repetition 235 according to a first set of transmission parameters configured for SBFD communications and a second set of transmission parameters configured for non-SBFD communications.

In some cases, by selectively transmitting the selective repetition 235, the UE 115-a may adaptively communicate during mixed symbol slots, thereby mitigating or otherwise reducing interference incurred by transmitting repetitions during mixed symbol slots according to an intra-slot frequency hopping configuration.

FIGS. 3A and 3B show examples of mixed symbol slots 301 and 302, respectively, that support uplink repetition frequency hopping in mixed SBFD and non-SBFD slots in accordance with one or more aspects of the present disclosure. The mixed symbol slots 301 and 302 may implement, or be implemented by, one or more aspects of the wireless communications system 200. For example, the mixed symbol slots 301 and 302 may be examples of a mixed symbol slot, such as the slot 210-c, described with reference to FIG. 2. For example, the mixed symbol slots 301 and 302 may include a set of SBFD symbols 305 associated with one or more downlink sub-bands (e.g., a portion of the bandwidth allocated to downlink resources 315) and one or more uplink sub-bands (e.g., a portion of the bandwidth associated with uplink resources 320) and a set of non-SBFD symbols 310 associated with uplink resources 320. In some cases, a UE 115 may determine whether to transmit a selective repetition 325 during the mixed symbol slots 301 and 302 based on an intra-slot frequency hopping configuration of the selective repetition 325.

The mixed symbol slot 301 illustrates a first example of an intra-slot frequency hopping configuration for the selective repetition 325. In some cases, the intra-slot frequency hopping configuration may indicate a frequency hop that splits the selective repetition into a first portion (e.g., using first time resources before a time domain location of the frequency hop) and a second portion (e.g., using second time resources after the time domain location of the frequency hop). The UE 115 may determine whether to transmit the portions of the selective repetition 325 according to an alignment of a boundary between the SBFD symbols 305 and the non-SBFD symbols 310 with the time resources associated with the first portion and the second portion.

For example, if the time domain location of the frequency hop aligns with the boundary between the SBFD symbols 305 and the non-SBFD symbols 310 (e.g., as shown in FIG. 3A), the UE 115 may determine the mixed symbol slot 301 to be available and may determine to transmit the selective repetition 325 during the mixed symbol slot 301. In other words, the UE 115 may determine to transmit the selective repetition 325 based on the second portion of the selective repetition 325 starting at a same symbol as a beginning of the non-SBFD symbols 310. In such examples, if the UE 115 uses available slot counting, the UE 115 may consider the mixed symbol slot 301 as available for uplink transmission. If the UE 115 uses consecutive physical slot counting, the UE 115 may count the selective repetition 325 (e.g., incrementing a counter associated with completed uplink repetitions).

In some cases, the UE 115 may identify a first set of transmission parameters associated with SBFD communications and a second set of transmission parameters associated with non-SBFD communications, which may be a same set of transmission parameters or different sets of transmission parameters. In some examples, if the first set of transmission parameters and the second set of transmission parameters include different transmission parameters, the UE 115 may transmit the first portion of the selective repetition 325 according to the first set of transmission parameters (e.g., within the SBFD symbols 305) and may transmit the second portion of the selective repetition 325 according to the second set of transmission parameters (e.g., within the non-SBFD symbols 310). As an alternative, the UE 115 may refrain from transmitting the selective repetition 325 when the first set of transmission parameters and the second set of transmission parameters include different transmission parameters. For instance, if the first set of transmission parameters and the second set of transmission parameters include different transmission parameters, the UE 115 may consider the slot unavailable and may postpone transmitting the selective repetition 325 until a subsequent available slot (e.g., when available slot counting is enabled) or may drop the selective repetition 325 and increment a counter associated with the uplink repetitions (e.g., when using consecutive physical slot counting). The transmission parameter may refer at least to power control configuration, spatial filter or QCL properties, or time configuration.

The mixed symbol slot 302 illustrates a second example of an intra-slot frequency hopping configuration for the selective repetition 325. In some cases, the intra-slot frequency hopping configuration may indicate a frequency hop that splits the selective repetition into a first portion (e.g., using first time resources before a time domain location of the frequency hop) and a second portion (e.g., using second time resources after the time domain location of the frequency hop). The UE 115 may determine whether to transmit the portions of the selective repetition 325 according to an alignment of a boundary between the SBFD symbols 305 and the non-SBFD symbols 310 with the time resources associated with the first portion and the second portion.

For example, if the time domain location of the frequency hop does not align with the boundary between the SBFD symbols 305 and the non-SBFD symbols 310 (e.g., as shown in FIG. 3B), the UE 115 may determine the mixed symbol slot 302 to be unavailable and may determine to refrain from transmitting the selective repetition 325 during the mixed symbol slot 302. In other words, the UE 115 may determine to refrain from transmitting the selective repetition 325 based on the second portion of the selective repetition 325 being mapped, in the time domain, across both the SBFD symbols 305 and the non-SBFD symbols 310. In such examples, if the UE 115 uses available slot counting, the UE 115 may consider the mixed symbol slot 302 as unavailable (e.g., non-available) for uplink transmission, and may postpone the selective repetition 325 until a subsequent (e.g., next) available slot. If the UE 115 uses consecutive physical slot counting, the UE 115 may count the selective repetition 325 (e.g., incrementing the counter of completed repetitions) and may drop both the first portion and the second portion, or may transmit the first portion while dropping the second portion.

Additionally, or alternatively, the UE 115 may determine whether to transmit the selective repetition 325 during the mixed symbol slot 302 based on one or more conditions. For example, the UE 115 may determine whether the mixed symbol slot 302 is considered as available for uplink transmission (e.g., if using available slot counting) or may determine whether to drop the selective repetition 325 (e.g., if using physical slot counting) according to the one or more conditions. In some cases, the one or more conditions may be associated with transmission parameters (e.g., transmission power, phase, timing, quasi-co location (QCL) information, or the like) configured for SBFD communications and non-SBFD communications, a presence of a guard period between the SBFD symbols 305 and the non-SBFD symbols 310, a phase coherency configured for the SBFD symbols 305 and the non-SBFD symbols 310, or any combination thereof. For example, the UE 115 may determine to transmit the selective repetition 325 during the mixed slot 302 if SBFD communications and non-SBFD communications share a same set of transmission parameters, no guard period exists between the SBFD symbols 305 and the non-SBFD symbols 310, and the same phase coherency is configured for the SBFD symbols 305 and the non-SBFD symbols 310.

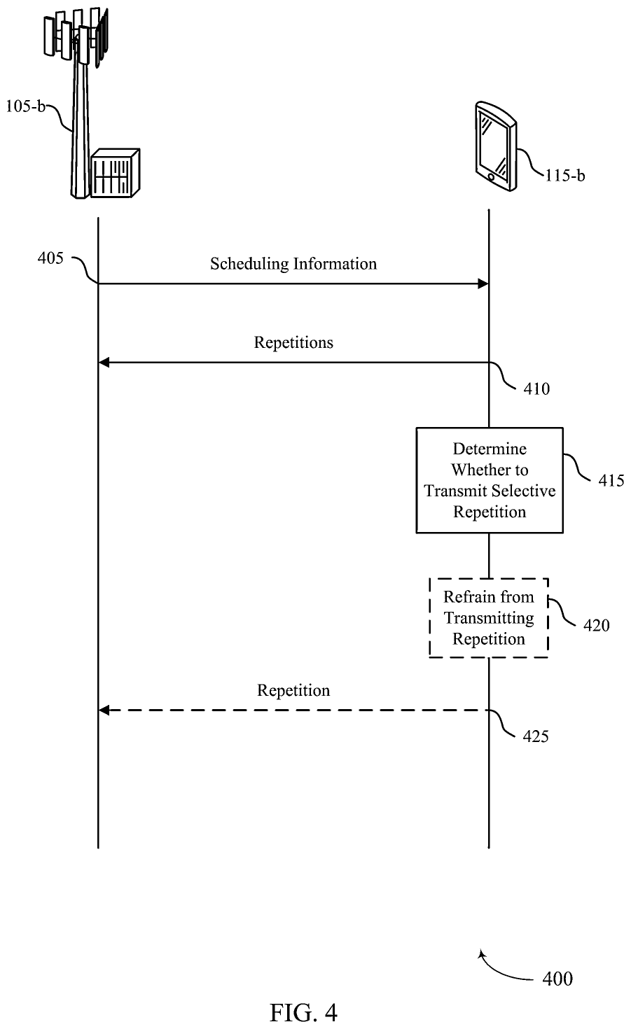

FIG. 4 shows an example of a process flow 400 that supports uplink repetition frequency hopping in mixed SBFD and non-SBFD slots in accordance with one or more aspects of the present disclosure. In some cases, the process flow 400 may implement, or be implemented by, one or more aspects of the wireless communications systems 100 and 200, as well as the mixed symbol slots 301 and 302. For example, the process flow 400 may include signaling between a network entity 105-b and a UE 115-b, which may be examples of corresponding devices described with reference to FIGS. 1 and 2. In some cases, the UE 115-b may selectively transmit a repetition of an uplink message during a mixed symbol slot (e.g., a slot including but SBFD and non-SBFD symbols) using techniques described with reference to FIGS. 1 through 3B. Alternative examples of the following may be implemented, where some processes are performed in a different order than described or are not performed. In some cases, processes may include additional features not mentioned below, or further processes may be added.

At 405, the network entity 105-b may transmit a control message including scheduling information to the UE 115-b. In some cases, the scheduling information may schedule multiple repetitions of an uplink message and may indicate an intra-slot frequency hopping configuration for each repetition. For example, the intra-slot frequency hopping configuration may indicate one or more frequency hops the UE 115-b is to apply when transmitting each repetition of the uplink message (e.g., separations in frequency between portions of a repetition during a corresponding slot).

At 410, the UE 115-b may transmit one or more repetitions of the uplink message during a set of one or more slots. In some cases, the one or more slots may include symbols of a same type. For example, the one or more slots may be associated with SBFD symbols (e.g., the UE 115-b transmits repetitions within an uplink sub-band of the slots) or with non-SBFD symbols (e.g., uplink slots). Additionally, or alternatively, the UE 115-b may determine which slots to use for transmitting the repetitions according to a type of counting enabled for the UE 115-b. For example, if available slot counting is enabled for the UE 115-b, the UE 115-b may determine whether a slot is available or unavailable (e.g., according to one or more conditions), and may transmit repetitions during available slots and may refrain from transmitting repetitions during unavailable slots. As an alternative, the UE 115-b may use consecutive physical slot counting, and may attempt to transmit repetitions during consecutive physical slots after receiving the scheduling information.

At 415, the UE 115-b may determine whether to transmit (e.g., selectively transmitting) one or more portions of a repetition of the uplink message during a slot that includes both SBFD symbols and non-SBFD symbols (e.g., a mixed symbol slot). For example, the slot may include a first set of symbols associated with SBFD communications and a second set of symbols associated with non-SBFD communications (e.g., uplink communications). In some cases, the UE 115-b may make the determination according to one or both of an availability of the slot and an alignment of a boundary between the first set of symbols and the second set of symbols with time resources associated with the one or more portions of the repetition. For example, the intra-slot frequency hopping configuration may indicate a first frequency hop that partitions the repetition into a first portion (e.g., before the time domain location of the first frequency hop) and a second portion (e.g., after the time domain location of the first frequency hop) that are separated, in the frequency domain, by the first frequency hop. In such examples, the UE 115-b may selectively transmit the first and second portions during the slot based on whether the portions are contained within a same type of symbol (e.g., SBFD or non-SBFD), transmission parameters associated with SBFD communications and non-SBFD communications, or both.

At 420, the UE 115-b may determine not to transmit the selective repetition during the mixed symbol slot, and may refrain from transmitting the repetition. As an example, the UE 115-b may consider the slot as unavailable due to the slot being associated with both the SBFD communications and the uplink communications (e.g., the UE 115-b performs no physical mapping of a channel in mixed symbol slots), and may refrain from transmitting the repetitions due to the slot being unavailable. In some cases, if available slot counting is enabled for the UE 115-b, the UE 115-b may postpone transmission of the one or more portions of the repetition until a second slot subsequent to the slot, wherein the second slot is available based on each symbol of the second slot being associated with the uplink communications (e.g., not a mixed symbol slot). In some other cases, if the UE 115-b uses consecutive physical slot counting, the UE 115-b may drop the one or more portions of the repetition and may increment a counter associated with the scheduled repetitions (e.g., indicating a completion of the repetition despite dropping the repetition).

As another example, the UE 115-b may refrain from transmitting the repetition according to time resources associated with the first portion and the second portion of the repetition and transmission parameters (e.g., transmit power, phase, timing, QCL relationships, or the like) configured for SBFD and non-SBFD communications. For example, if first time resources associated with the first portion are within the first set of symbols and second time resources associated with the second portion are within the second set of symbols (e.g., the time domain location of the first frequency hop aligns with the boundary between the first set of symbols and the second set of symbols), the UE 115-b may refrain from transmitting the first portion and the second portion when the SBFD communications are associated with a first set of transmission parameters that are different from a second set of transmission parameters associated with the uplink communications.

In another example, if the first time resources associated with the first portion are within the first set of symbols and the second time resources associated with the second portion are at least partially within both the first set of symbols and the second set of symbols (e.g., the second portion extends into both the SBFD and non-SBFD symbols), the UE 115-b may refrain from transmitting the first portion and the second portion based on the second time resources being at least partially within both the first set of symbols and the second set of symbols. Alternatively, in such examples, if the UE 115-b uses consecutive physical slot counting, the UE 115-b may transmit the first portion of the repetition and may drop the second portion due to the second portion being associated with both SBFD and non-SBFD symbols.

At 425, the UE 115-b may determine to transmit the selective repetition during the mixed symbol slot. For example, if the first time resources associated with the first portion are within the first set of symbols and the second time resources associated with the second portion are within the second set of symbols (e.g., the time domain location of the first frequency hop aligns with the boundary between the first set of symbols and the second set of symbols), the UE 115-b may consider the slot available and may transmit the first portion and the second portion during the slot. Additionally, in such examples, if the SBFD communications are associated with a first set of transmission parameters that are different from a second set of transmission parameters associated with the uplink communications, the UE 115-b may transmit, during the first time resources, the first portion in accordance with a first set of transmission parameters and may transmit, during the second time resources, the second portion in accordance with a second set of transmission parameters.

As another example, if the first time resources associated with the first portion are within the first set of symbols and the second time resources associated with the second portion are at least partially within both the first set of symbols and the second set of symbols (e.g., the second portion extends into both the SBFD and non-SBFD symbols), the UE 115-b may transmit the first portion and the second portion based on both the first set of transmission parameters associated with the SBFD communications and a second set of transmission parameters associated with the uplink communications including a same set of transmission parameters. For example, if the SBFD symbols and the non-SBFD symbols are configured with the same transmission parameters (e.g., transmit power, phase, timing, QCL relationships), no guard period is present between the SBFD and non-SBFD symbols, and phase coherency is maintained across the SBFD symbols and the non-SBFD symbols, the UE 115-b may determine to transmit the first and second portions of the repetition.

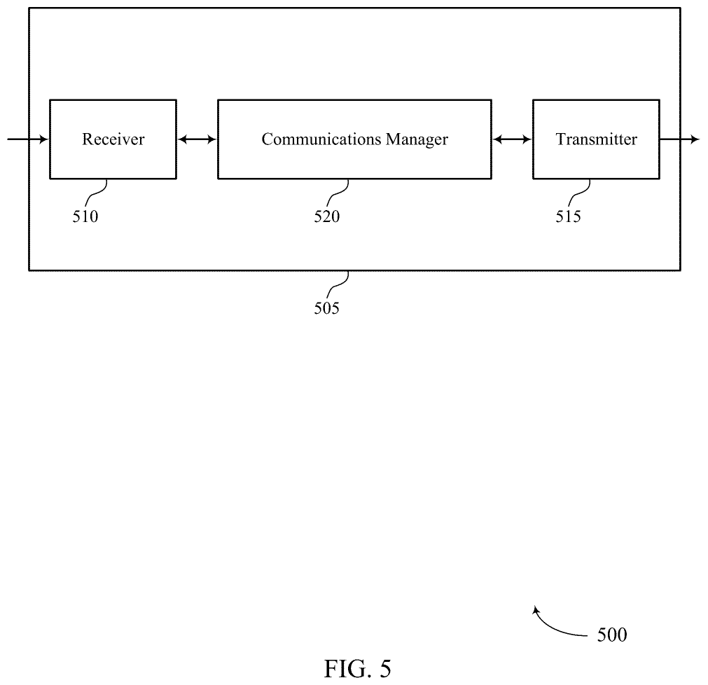

FIG. 5 shows a block diagram 500 of a device 505 that supports uplink repetition frequency hopping in mixed SBFD and non-SBFD slots in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink repetition frequency hopping in mixed SBFD and non-SBFD slots). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink repetition frequency hopping in mixed SBFD and non-SBFD slots). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of uplink repetition frequency hopping in mixed SBFD and non-SBFD slots as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message including scheduling information for a set of multiple repetitions of an uplink message for transmission by the UE, the scheduling information indicating an intra-slot frequency hopping configuration for each repetition of the set of multiple repetitions. The communications manager 520 is capable of, configured to, or operable to support a means for selectively transmitting, during a slot including a first set of symbols associated with SBFD communications and a second set of symbols associated with uplink communications, one or more portions of a repetition of the set of multiple repetitions based on one or both of an availability of the slot and an alignment of a boundary between the first set of symbols and the second set of symbols with time resources associated with the one or more portions of the repetition, where the time resources are based on one or more frequency hops indicated by the intra-slot frequency hopping configuration.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for selectively transmitting uplink repetitions during mixed symbol slots, thereby improving communication resource utilization and a reliability of uplink communications during mixed symbol slots.

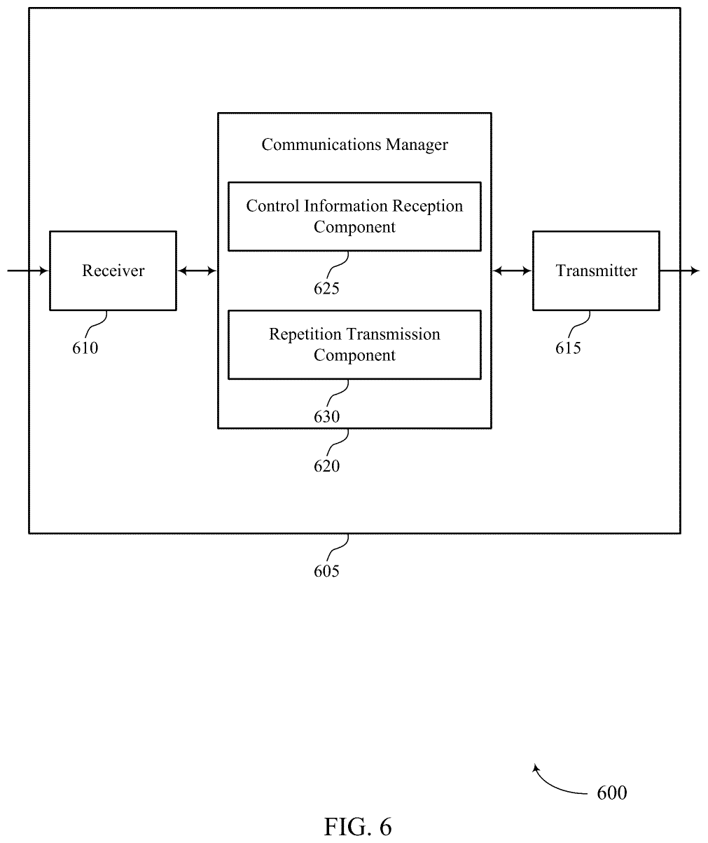

FIG. 6 shows a block diagram 600 of a device 605 that supports uplink repetition frequency hopping in mixed SBFD and non-SBFD slots in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink repetition frequency hopping in mixed SBFD and non-SBFD slots). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink repetition frequency hopping in mixed SBFD and non-SBFD slots). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink repetition frequency hopping in mixed SBFD and non-SBFD slots as described herein. For example, the communications manager 620 may include a control message reception component 625 a repetition transmission component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control message reception component 625 is capable of, configured to, or operable to support a means for receiving a control message including scheduling information for a set of multiple repetitions of an uplink message for transmission by the UE, the scheduling information indicating an intra-slot frequency hopping configuration for each repetition of the set of multiple repetitions. The repetition transmission component 630 is capable of, configured to, or operable to support a means for selectively transmitting, during a slot including a first set of symbols associated with SBFD communications and a second set of symbols associated with uplink communications, one or more portions of a repetition of the set of multiple repetitions based on one or both of an availability of the slot and an alignment of a boundary between the first set of symbols and the second set of symbols with time resources associated with the one or more portions of the repetition, where the time resources are based on one or more frequency hops indicated by the intra-slot frequency hopping configuration.

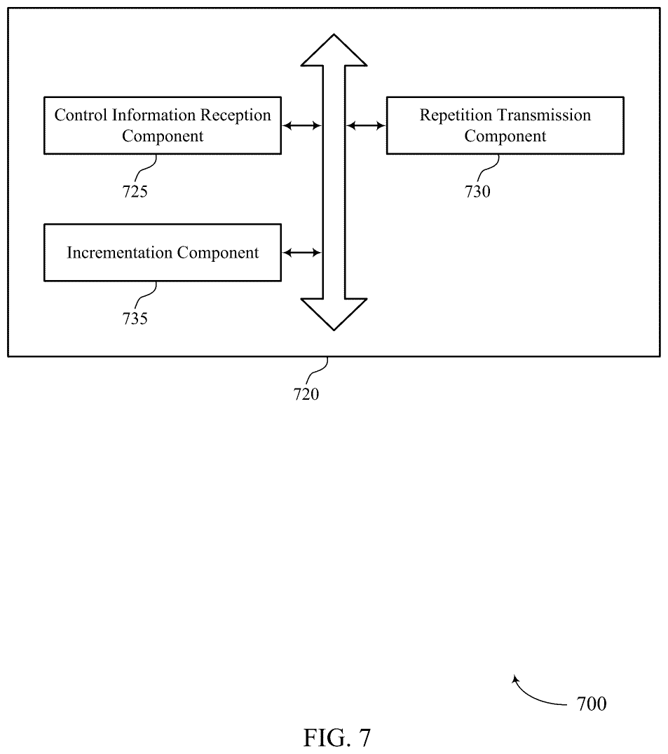

FIG. 7 shows a block diagram 700 of a communications manager 720 that supports uplink repetition frequency hopping in mixed SBFD and non-SBFD slots in accordance with one or more aspects of the present disclosure. The communications manager 720 may be an example of aspects of a communications manager 520, a communications manager 620, or both, as described herein. The communications manager 720, or various components thereof, may be an example of means for performing various aspects of uplink repetition frequency hopping in mixed SBFD and non-SBFD slots as described herein. For example, the communications manager 720 may include a control message reception component 725, a repetition transmission component 730, a transmission dropping component 735, a counter management component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control message reception component 725 is capable of, configured to, or operable to support a means for receiving a control message including scheduling information for a set of multiple repetitions of an uplink message for transmission by the UE, the scheduling information indicating an intra-slot frequency hopping configuration for each repetition of the set of multiple repetitions. The repetition transmission component 730 is capable of, configured to, or operable to support a means for selectively transmitting, during a slot including a first set of symbols associated with SBFD communications and a second set of symbols associated with uplink communications, one or more portions of a repetition of the set of multiple repetitions based on one or both of an availability of the slot and an alignment of a boundary between the first set of symbols and the second set of symbols with time resources associated with the one or more portions of the repetition, where the time resources are based on one or more frequency hops indicated by the intra-slot frequency hopping configuration.

In some examples, to support selectively transmitting the one or more portions of the repetition, the repetition transmission component 730 is capable of, configured to, or operable to support a means for refraining from transmitting the one or more portions of the repetition during the slot based on a determination that the slot is unavailable, where the slot is determined to be unavailable based on the slot being associated with both the SBFD communications and the uplink communications.

In some examples, to support refraining from transmitting the one or more portions of the repetition, the repetition transmission component 730 is capable of, configured to, or operable to support a means for postponing transmission of the one or more portions of the repetition until a second slot subsequent to the slot, where the second slot is available based on each symbol of the second slot being associated with the uplink communications.

In some examples, to support refraining from transmitting the one or more portions of the repetition, the transmission dropping component 735 is capable of, configured to, or operable to support a means for dropping the one or more portions of the repetition during the slot. In some examples, to support refraining from transmitting the one or more portions of the repetition, the counter management component 740 is capable of, configured to, or operable to support a means for incrementing a counter associated with the set of multiple repetitions based on dropping the one or more portions of the repetition, where incrementing the counter indicates a completion of the repetition.

In some examples, the one or more portions of the repetition include at least a first portion and a second portion that are separated, in a frequency domain, by a first frequency hop of the one or more frequency hops; and first time resources associated with the first portion are within the first set of symbols and second time resources associated with the second portion are within the second set of symbols based on a time domain location of the first frequency hop aligning with the boundary between the first set of symbols and the second set of symbols.

In some examples, to support selectively transmitting the one or more portions of the repetition, the repetition transmission component 730 is capable of, configured to, or operable to support a means for transmitting the first portion and the second portion during the slot based on the first time resources being within the first set of symbols and the second portion being within the second set of symbols.

In some examples, to support transmitting the one or more portions of the repetition, the repetition transmission component 730 is capable of, configured to, or operable to support a means for transmitting, during the first time resources, the first portion in accordance with a first set of transmission parameters associated with the SBFD communications. In some examples, to support transmitting the one or more portions of the repetition, the repetition transmission component 730 is capable of, configured to, or operable to support a means for transmitting, during the second time resources, the second portion in accordance with a second set of transmission parameters associated with the uplink communications.

In some examples, to support selectively transmitting the one or more portions of the repetition, the repetition transmission component 730 is capable of, configured to, or operable to support a means for refraining from transmitting the first portion and the second portion during the slot based on the SBFD communications being associated with a first set of transmission parameters that are different from a second set of transmission parameters associated with the uplink communications.

In some examples, the one or more portions of the repetition include at least a first portion and a second portion that are separated, in a frequency domain, by a first frequency hop of the one or more frequency hops; and first time resources associated with the first portion are within the first set of symbols and second time resources associated with the second portion are at least partially within both the first set of symbols and the second set of symbols.

In some examples, to support selectively transmitting the one or more portions of the repetition, the repetition transmission component 730 is capable of, configured to, or operable to support a means for refraining from transmitting the first portion and the second portion during the slot based on the second time resources being at least partially within both the first set of symbols and the second set of symbols.

In some examples, to support selectively transmitting the one or more portions of the repetition, the repetition transmission component 730 is capable of, configured to, or operable to support a means for transmitting the first portion during the first time resources. In some examples, to support selectively transmitting the one or more portions of the repetition, the transmission dropping component 735 is capable of, configured to, or operable to support a means for dropping the second portion based on the second time resources being at least partially within both the first set of symbols and the second set of symbols.

In some examples, to support selectively transmitting the one or more portions of the repetition, the repetition transmission component 730 is capable of, configured to, or operable to support a means for transmitting the one or more portions of the repetition during the slot based on both a first set of transmission parameters associated with the SBFD communications and a second set of transmission parameters associated with the uplink communications including a same set of transmission parameters.

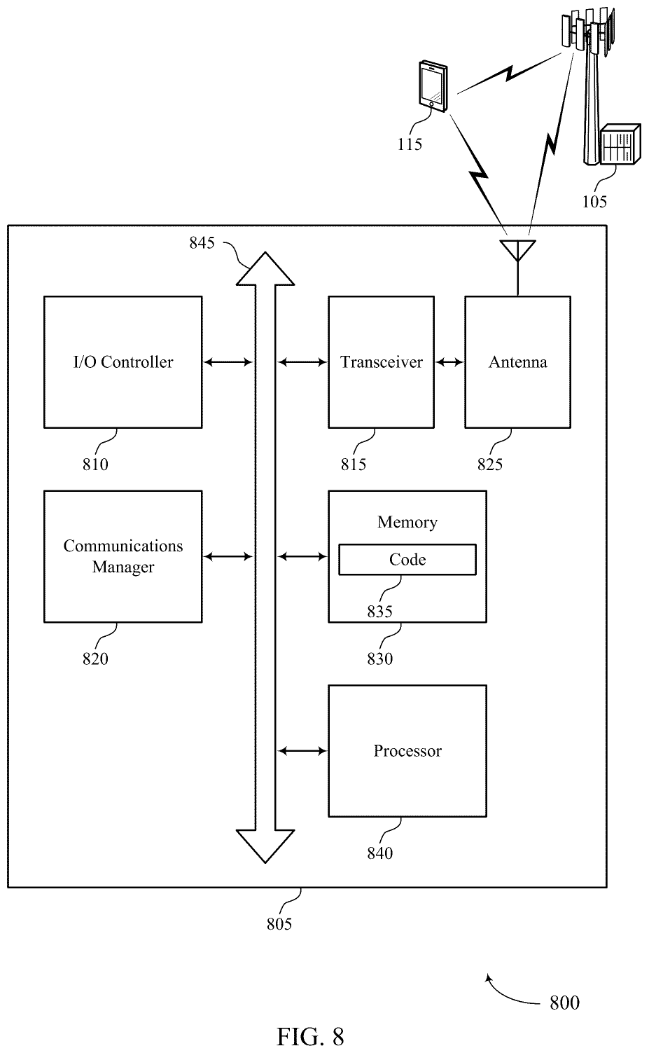

FIG. 8 shows a diagram of a system 800 including a device 805 that supports uplink repetition frequency hopping in mixed SBFD and non-SBFD slots in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting uplink repetition frequency hopping in mixed SBFD and non-SBFD slots). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message including scheduling information for a set of multiple repetitions of an uplink message for transmission by the UE, the scheduling information indicating an intra-slot frequency hopping configuration for each repetition of the set of multiple repetitions. The communications manager 820 is capable of, configured to, or operable to support a means for selectively transmitting, during a slot including a first set of symbols associated with SBFD communications and a second set of symbols associated with uplink communications, one or more portions of a repetition of the set of multiple repetitions based on one or both of an availability of the slot and an alignment of a boundary between the first set of symbols and the second set of symbols with time resources associated with the one or more portions of the repetition, where the time resources are based on one or more frequency hops indicated by the intra-slot frequency hopping configuration.

By including or configuring the communications manager 820 in accordance with examples as described herein, the device 805 may support techniques for selectively transmitting uplink repetitions during mixed symbol slots, thereby improving communication resource utilization and a reliability of uplink communications during mixed symbol slots.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of uplink repetition frequency hopping in mixed SBFD and non-SBFD slots as described herein, or the at least one processor 840 and the at least one memory 830 may be otherwise configured to, individually or collectively, perform or support such operations.

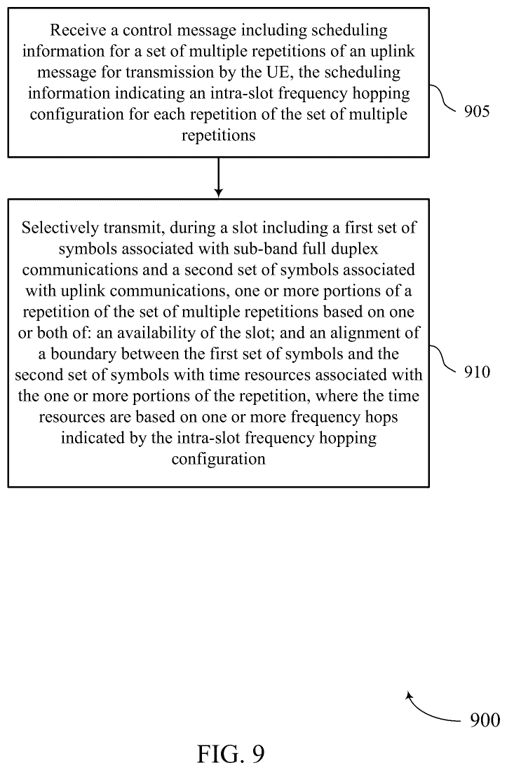

FIG. 9 shows a flowchart illustrating a method 900 that supports uplink repetition frequency hopping in mixed SBFD and non-SBFD slots in accordance with aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a control message including scheduling information for a set of multiple repetitions of an uplink message for transmission by the UE, the scheduling information indicating an intra-slot frequency hopping configuration for each repetition of the set of multiple repetitions. The operations of block 905 may be performed in accordance with examples as disclosed herein. In some examples, aspects of the operations of 905 may be performed by a control message reception component 725 as described with reference to FIG. 7.

At 910, the method may include selectively transmitting, during a slot including a first set of symbols associated with SBFD communications and a second set of symbols associated with uplink communications, one or more portions of a repetition of the set of multiple repetitions based on one or both of an availability of the slot and an alignment of a boundary between the first set of symbols and the second set of symbols with time resources associated with the one or more portions of the repetition, where the time resources are based on one or more frequency hops indicated by the intra-slot frequency hopping configuration. The operations of block 910 may be performed in accordance with examples as disclosed herein. In some examples, aspects of the operations of 910 may be performed by a repetition transmission component 730 as described with reference to FIG. 7.

The following provides an overview of aspects of the present disclosure:
Aspect 1: A method for wireless communications by a UE, comprising: receiving a control message comprising scheduling information for a plurality of repetitions of an uplink message for transmission by the UE, the scheduling information indicating an intra-slot frequency hopping configuration for each repetition of the plurality of repetitions; and selectively transmitting, during a slot comprising a first set of symbols associated with SBFD communications and a second set of symbols associated with uplink communications, one or more portions of a repetition of the plurality of repetitions based at least in part on one or both of an availability of the slot and a boundary between the first set of symbols and the second set of symbols relative to time resources associated with the one or more portions of the repetition, wherein the time resources are based at least in part on one or more frequency hops indicated by the intra-slot frequency hopping configuration.
Aspect 2: The method of aspect 1, wherein selectively transmitting the one or more portions of the repetition comprises: refraining from transmitting the one or more portions of the repetition during the slot based at least in part on a determination that the slot is unavailable, wherein the slot is determined to be unavailable based at least in part on the slot being associated with both the SBFD communications and the uplink communications.
Aspect 3: The method of aspect 2, wherein refraining from transmitting the one or more portions of the repetition comprises: postponing transmission of the one or more portions of the repetition until a second slot subsequent to the slot, wherein the second slot is available based at least in part on each symbol of the second slot being associated with the uplink communications.
Aspect 4: The method of any of aspects 2 through 3, wherein refraining from transmitting the one or more portions of the repetition comprises: dropping the one or more portions of the repetition during the slot; and incrementing a counter associated with the plurality of repetitions based at least in part on dropping the one or more portions of the repetition, wherein incrementing the counter indicates a completion of the repetition.
Aspect 5: The method of any of aspects 1 through 4, wherein the one or more portions of the repetition comprise at least a first portion and a second portion that are separated, in a frequency domain, by a first frequency hop of the one or more frequency hops; and first time resources associated with the first portion are within the first set of symbols and second time resources associated with the second portion are within the second set of symbols based at least in part on a time domain location of the first frequency hop aligning with the boundary between the first set of symbols and the second set of symbols.
Aspect 6: The method of aspect 5, wherein the slot is determined to be available for transmission, wherein selectively transmitting the one or more portions of the repetition comprises: transmitting the first portion and the second portion during the slot based at least in part on the first time resources being within the first set of symbols and the second portion being within the second set of symbols; and incrementing a counter associated with the plurality of repetitions based at least in part on transmitting the first portion and the second portion, wherein incrementing the counter indicates a completion of the repetition.
Aspect 7: The method of aspect 6, wherein transmitting the one or more portions of the repetition comprises: transmitting, during the first time resources, the first portion in accordance with a first set of transmission parameters associated with the SBFD communications; and transmitting, during the second time resources, the second portion in accordance with a second set of transmission parameters associated with the uplink communications.
Aspect 8: The method of any of aspects 5 through 7, wherein selectively transmitting the one or more portions of the repetition comprises: refraining from transmitting the first portion and the second portion during the slot based at least in part on the SBFD communications being associated with a first set of transmission parameters that are different from a second set of transmission parameters associated with the uplink communications.
Aspect 9: The method of any of aspects 1 through 8, wherein the one or more portions of the repetition comprise at least a first portion and a second portion that are separated, in a frequency domain, by a first frequency hop of the one or more frequency hops; and first time resources associated with the first portion are within the first set of symbols and second time resources associated with the second portion are at least partially within both the first set of symbols and the second set of symbols.
Aspect 10: The method of aspect 9, wherein selectively transmitting the one or more portions of the repetition comprises: refraining from transmitting the first portion and the second portion during the slot based at least in part on the second time resources being at least partially within both the first set of symbols and the second set of symbols.
Aspect 11: The method of any of aspects 9 through 10, wherein selectively transmitting the one or more portions of the repetition comprises: transmitting the first portion during the first time resources; and dropping the second portion based at least in part on the second time resources being at least partially within both the first set of symbols and the second set of symbols.
Aspect 12: The method of any of aspects 9 through 11, wherein selectively transmitting the one or more portions of the repetition comprises: transmitting the one or more portions of the repetition during the slot based at least in part on a determination that the slot is available, wherein the slot is determined to be available based at least in part on both a first set of transmission parameters associated with the SBFD communications and a second set of transmission parameters associated with the uplink communications comprising a same set of transmission parameters.
Aspect 13: The method of aspect 12, wherein the same set of transmission parameters comprises a transmission power, a phase, a transmission timing parameter, a QCL relationship, a guard period, or any combination thereof.
Aspect 14: A UE for wireless communications, comprising one or more memories storing processor-executable code, and one or more processors coupled with the one or more memories and individually or collectively operable to execute the code to cause the UE to perform a method of any of aspects 1 through 13.
Aspect 15: A UE for wireless communications, comprising at least one means for performing a method of any of aspects 1 through 13.
Aspect 16: A non-transitory computer-readable medium storing code for wireless communications, the code comprising instructions executable by a processor to perform a method of any of aspects 1 through 13.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message comprising scheduling information for a plurality of repetitions of an uplink message for transmission by the UE, the scheduling information indicating an intra-slot frequency hopping configuration for each repetition of the plurality of repetitions; and
selectively transmit, during a slot comprising a first set of symbols associated with sub-band full duplex communications and a second set of symbols associated with uplink communications, one or more portions of a repetition of the plurality of repetitions based at least in part on one or both of:
an availability of the slot; and
an alignment of a boundary between the first set of symbols and the second set of symbols with time resources associated with the one or more portions of the repetition, wherein the time resources are based at least in part on one or more frequency hops indicated by the intra-slot frequency hopping configuration.

2. The UE of claim 1, wherein, to selectively transmit the one or more portions of the repetition, the one or more processors are individually or collectively operable to execute the code to cause the UE to:
refrain from transmitting the one or more portions of the repetition during the slot based at least in part on a determination that the slot is unavailable, wherein the slot is determined to be unavailable based at least in part on the slot being associated with both the sub-band full duplex communications and the uplink communications.

3. The UE of claim 2, wherein, to refrain from transmitting the one or more portions of the repetition, the one or more processors are individually or collectively operable to execute the code to cause the UE to:
postpone transmission of the one or more portions of the repetition until a second slot subsequent to the slot, wherein the second slot is available based at least in part on each symbol of the second slot being associated with the uplink communications.

4. The UE of claim 2, wherein, to refrain from transmitting the one or more portions of the repetition, the one or more processors are individually or collectively operable to execute the code to cause the UE to:
drop the one or more portions of the repetition during the slot; and
increment a counter associated with the plurality of repetitions based at least in part on dropping the one or more portions of the repetition, wherein incrementing the counter indicates a completion of the repetition.

5. The UE of claim 1, wherein:
the one or more portions of the repetition comprise at least a first portion and a second portion that are separated, in a frequency domain, by a first frequency hop of the one or more frequency hops; and
first time resources associated with the first portion are within the first set of symbols and second time resources associated with the second portion are within the second set of symbols based at least in part on a time domain location of the first frequency hop aligning with the boundary between the first set of symbols and the second set of symbols.

6. The UE of claim 5, wherein the slot is determined to be available for transmission, and wherein to selectively transmit the one or more portions of the repetition, the one or more processors are individually or collectively operable to execute the code to cause the UE to:
transmit the first portion and the second portion during the slot based at least in part on the first time resources being within the first set of symbols and the second portion being within the second set of symbols; and
increment a counter associated with the plurality of repetitions based at least in part on transmitting the first portion and the second portion, wherein incrementing the counter indicates a completion of the repetition.

7. The UE of claim 6, wherein, to transmit the one or more portions of the repetition, the one or more processors are individually or collectively operable to execute the code to cause the UE to:
transmit, during the first time resources, the first portion in accordance with a first set of transmission parameters associated with the sub-band full duplex communications; and
transmit, during the second time resources, the second portion in accordance with a second set of transmission parameters associated with the uplink communications.

8. The UE of claim 5, wherein, to selectively transmit the one or more portions of the repetition, the one or more processors are individually or collectively operable to execute the code to cause the UE to:
refrain from transmitting the first portion and the second portion during the slot based at least in part on the sub-band full duplex communications being associated with a first set of transmission parameters that are different from a second set of transmission parameters associated with the uplink communications.

9. The UE of claim 5, wherein, to selectively transmit the one or more portions of the repetition, the one or more processors are individually or collectively operable to execute the code to cause the UE to:
transmit the one or more portions of the repetition during the slot based at least in part on a determination that the slot is available, wherein the slot is determined to be available based at least in part on both a first set of transmission parameters associated with the sub-band full duplex communications and a second set of transmission parameters associated with the uplink communications comprising a same set of transmission parameters.

10. The UE of claim 9, wherein the same set of transmission parameters comprises:
a transmission power, a phase, a transmission timing parameter, a quasi-co-location relationship, a guard period, or any combination thereof.

11. A method for wireless communications by a user equipment (UE), comprising:
receiving a control message comprising scheduling information for a plurality of repetitions of an uplink message for transmission by the UE, the scheduling information indicating an intra-slot frequency hopping configuration for each repetition of the plurality of repetitions; and
selectively transmitting, during a slot comprising a first set of symbols associated with sub-band full duplex communications and a second set of symbols associated with uplink communications, one or more portions of a repetition of the plurality of repetitions based at least in part on one or both of:
an availability of the slot; and
an alignment of a boundary between the first set of symbols and the second set of symbols with time resources associated with the one or more portions of the repetition, wherein the time resources are based at least in part on one or more frequency hops indicated by the intra-slot frequency hopping configuration.

12. The method of claim 11, wherein selectively transmitting the one or more portions of the repetition comprises:
refraining from transmitting the one or more portions of the repetition during the slot based at least in part on a determinations that the slot is unavailable, wherein the slot is determined to be unavailable based at least in part on the slot being associated with both the sub-band full duplex communications and the uplink communications.

13. The method of claim 12, wherein refraining from transmitting the one or more portions of the repetition comprises:
postponing transmission of the one or more portions of the repetition until a second slot subsequent to the slot, wherein the second slot is available based at least in part on each symbol of the second slot being associated with the uplink communications.

14. The method of claim 12, wherein refraining from transmitting the one or more portions of the repetition comprises:
dropping the one or more portions of the repetition during the slot; and
incrementing a counter associated with the plurality of repetitions based at least in part on dropping the one or more portions of the repetition, wherein incrementing the counter indicates a completion of the repetition.

15. The method of claim 11, wherein:
the one or more portions of the repetition comprise at least a first portion and a second portion that are separated, in a frequency domain, by a first frequency hop of the one or more frequency hops; and
first time resources associated with the first portion are within the first set of symbols and second time resources associated with the second portion are within the second set of symbols based at least in part on a time domain location of the first frequency hop aligning with the boundary between the first set of symbols and the second set of symbols.

16. The method of claim 15, wherein the slot is determined to be available for transmission, and wherein selectively transmitting the one or more portions of the repetition comprises:
transmitting the first portion and the second portion during the slot based at least in part on the first time resources being within the first set of symbols and the second portion being within the second set of symbols; and
incrementing a counter associated with the plurality of repetitions based at least in part on transmitting the first portion and the second portion, wherein incrementing the counter indicates a completion of the repetition.

17. The method of claim 16, wherein transmitting the one or more portions of the repetition comprises:
transmitting, during the first time resources, the first portion in accordance with a first set of transmission parameters associated with the sub-band full duplex communications; and
transmitting, during the second time resources, the second portion in accordance with a second set of transmission parameters associated with the uplink communications.

18. The method of claim 15, wherein selectively transmitting the one or more portions of the repetition comprises:
refraining from transmitting the first portion and the second portion during the slot based at least in part on the sub-band full duplex communications being associated with a first set of transmission parameters that are different from a second set of transmission parameters associated with the uplink communications.

19. The method of claim 15, wherein selectively transmitting the one or more portions of the repetition comprises:
transmitting the one or more portions of the repetition during the slot based at least in part on a determination that the slot is available, wherein the slot is determined to be available based at least in part on both a first set of transmission parameters associated with the sub-band full duplex communications and a second set of transmission parameters associated with the uplink communications comprising a same set of transmission parameters.

20. A non-transitory computer-readable medium storing code for wireless communication, the code comprising instructions executable by one or more processors to:
receive a control message comprising scheduling information for a plurality of repetitions of an uplink message for transmission by a user equipment (UE), the scheduling information indicating an intra-slot frequency hopping configuration for each repetition of the plurality of repetitions; and
selectively transmit, during a slot comprising a first set of symbols associated with sub-band full duplex communications and a second set of symbols associated with uplink communications, one or more portions of a repetition of the plurality of repetitions based at least in part on one or both of:
an availability of the slot; and
an alignment of a boundary between the first set of symbols and the second set of symbols with time resources associated with the one or more portions of the repetition, wherein the time resources are based at least in part on one or more frequency hops indicated by the intra-slot frequency hopping configuration.
